(19) United States
(12) Patent Application Publication
(10) Pub. No.: US 2014/0055347 A1
(43) Pub. Date: Feb. 27, 2014

(54) IMAGING TASK PIPELINE ACCELERATION

(71) Applicants: Stewart N. Taylor, Los Altos Hills, CA (US); Scott A. Krig, Folsom, CA (US)

(72) Inventors: Stewart N. Taylor, Los Altos Hills, CA (US); Scott A. Krig, Folsom, CA (US)

(21) Appl. No.: 13/993,568

(22) PCT Filed: Dec. 29, 2011
(86) PCT No.: PCT/US11/67729

§ 371 Date: Jun. 12, 2013

(51) Int. Cl. G06T 1/20

(52) U.S. Cl. CPC G06T 1/20
USPC 345/156; 345/501

(57) ABSTRACT

Systems, methods, and articles of manufacture for imaging task pipeline acceleration are provided. Imaging tasks in a pipeline of a system having heterogeneous processing capabilities, for example, may be configured to increase the speed at which such imaging tasks are accomplished.

### BACKGROUND OF THE INVENTION

Image processing is a component of computer system functionality that continues to increase in criticality and complexity. The speed with which image processing tasks can be accomplished has direct impact on computer system performance and often on end-user experiences. With the advent of multi-threading functionality and multi-core processing devices, imaging task speeds have increased dramatically. As the demand and complexity of imaging task processing continues to increase, however, acceleration of imaging task processing beyond the capabilities of current practices is desirable.

### BRIEF DESCRIPTION OF THE DRAWINGS

An understanding of embodiments described herein and many of the attendant advantages thereof may be readily obtained by reference to the following detailed description when considered with the accompanying drawings, wherein:

FIG. 1 is a block diagram of a system according to some embodiments;

FIG. 2 is a block diagram of a system according to some embodiments;

FIG. 3 is flow diagram of a method according to some embodiments;

FIG. 4 is flow diagram of a method according to some embodiments;

FIG. 5 is a diagram of an example graph according to some embodiments;

FIG. 6 is a block diagram of an apparatus according to some embodiments; and

FIG. 7A and FIG. 7B are perspective diagrams of example data storage devices according to some embodiments.

### DETAILED DESCRIPTION OF EXAMPLE EMBODIMENTS

Embodiments described herein are descriptive of systems, apparatus, methods, and articles of manufacture for utilizing heterogeneous processing resources to accelerate imaging tasks in a pipeline. Some embodiments comprise, for example, determining (e.g., by a specially-programmed computer processing device) a set of image processing tasks, determining (e.g., by the specially-programmed computer processing device) one or more characteristics of the set of image processing tasks, determining (e.g., by the specially-programmed computer processing device) a set of heterogeneous processing resources that are available to execute the set of image processing tasks, determining (e.g., by the specially-programmed computer processing device) one or more characteristics of the set of heterogeneous processing resources, and allocating (e.g., by the specially-programmed computer processing device) based on (i) the one or more characteristics of the set of image processing tasks and (ii) the one or more characteristics of the set of heterogeneous processing resources, (1) a first sub-set of the set of image processing tasks to a first sub-set of the heterogeneous processing resources, and (2) a second sub-set of the set of image processing tasks to a second sub-set of the heterogeneous processing resources.

In such a manner, for example, a system having a plurality of available heterogeneous processing resources may implement rules to efficiently allocate image processing tasks and accordingly accelerate the imaging tasks within the task pipeline. Acceleration of the imaging tasks in the pipeline may increase the speed at which a system is operable to accomplish image processing and/or increase the capability of the system to perform other tasks, increase processing and/or communications bandwidth, and/or decrease power consumption (e.g., by reducing power requirements needed to process tasks and/or by reducing cooling loads).

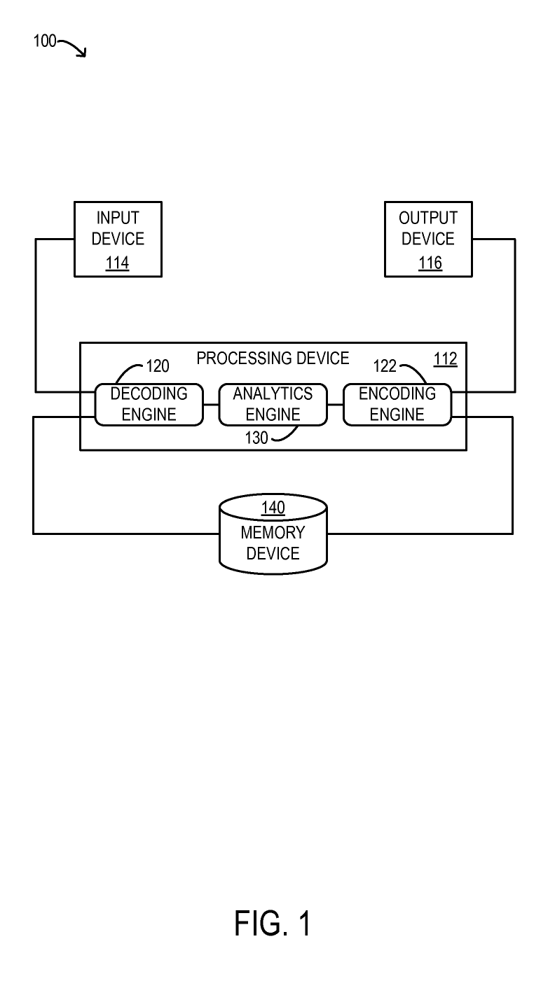

Referring first to FIG. 1, a block diagram of a system 100 according to some embodiments is shown. In some embodiments, the system 100 may comprise a processing device 112, an input device 114, and/or an output device 116. According to some embodiments, the processing device 112 may comprise and/or execute various code, programs, applications, algorithms, and/or other instructions such as may be implemented by a decoding engine 120, an encoding engine 122, and/or an analytics engine 130. In some embodiments, any or all code, microcode, firmware, hardware, software, and/or other devices or objects that comprise the decoding engine 120, the encoding engine 122, and/or the analytics engine 130 may be stored in a memory device 140. The memory device 140 may, for example, be coupled to and/or in communication with the processing device 112 such that instructions stored by the memory device 140 may be executed by the processing device 112 and/or may cause the processing device 112 to otherwise operate in accordance with embodiments described herein.

In some embodiments, the system 100 may comprise an electronic device such as a consumer electronic device. The system 100 may comprise, for example, a Personal Computer (PC), a cellular telephone or smart-phone, a tablet and/or laptop computer, a printer and/or printing device, and/or any other type, configuration, and/or combination of user or network device that is or becomes known or practicable. According to some embodiments, the system 100 may receive data such as image data via the input device 114. The image data may, for example, comprise encoded photograph, print data, and/or video data such as may be descriptive and/or indicative of a print job or a movie or TV episode. In some embodiments, the processing device 112 may receive the image data from the input device 114 and/or may execute and/or activate the decoding engine 120. The decoding engine 120 may, for example, apply and/or utilize a decoding algorithm and/or standard such as the “Information technology—Digital compression and coding of continuous-tone still images” standard 10918-4 published by the International Organization for Standards (ISO)/International Electrotechnical Commission (IEC) in 1999 (ISO/IEC 10918-4:1999) and published by the International Telecommunication Union (ITU) as Recommendation T.86 in June, 1998, to decode the image data.

According to some embodiments, the processing device 112 may activate and/or execute the analytics engine 130 to process the image data (e.g., the decoded image data) in accordance with one or more rules and/or instructions. The analytics engine 130 may, for example, compress, decompress, filter, reduce, enlarge, correct, balance, and/or convert the image data. In some embodiments, the processing device 112 may activate and/or execute the encoding engine 122 to encode the image data (e.g., the processed image data). Once the image data has been processed as desired (e.g., by execution of the analytics engine 130 by the processing device 112), for example, the encoding engine 122 may apply and/or utilize an encoding algorithm (e.g., in accordance with the decoding standard utilized by the decoding device 120 or in accordance with a different standard) and the image data may be sent to (and accordingly received by) the output device 116.

In some embodiments, the processing device 112 may comprise any type, configuration, and/or quantity of a processing object and/or device that is or becomes know or practicable. The processing device 112 may, for example, comprise one or more Central Processing Unit (CPU) devices, micro-engines (e.g., “fixed-function” processing devices), signal processing devices, graphics processors, and/or combinations thereof. The processing device 112 may, in some embodiments, comprise an electronic and/or computerized processing device operable and/or configured to process image data as described herein. According to some embodiments, the input device 114 may comprise any type, configuration, and/or quantity of an input object and/or device that is or becomes know or practicable. The input device 114 may comprise, for example, a keyboard, keypad, port, path, router, Network Interface Card (NIC), and/or other type of network device. The input device 114 may, in some embodiments, comprise an electrical and/or network path operable and/or configured to receive image data as described herein. In some embodiments, the output device 116 may comprise may comprise any type, configuration, and/or quantity of an input object and/or device that is or becomes know or practicable. The output device 116 may comprise, for example, a display device, an audio device, a port, path, and/or other network device. The output device 116 may, in some embodiments, comprise an electrical and/or network path operable and/or configured to transmit, broadcast, and/or provide image data as described herein.

According to some embodiments, the memory device 140 may comprise any type, configuration, and/or quantity of a memory object and/or device that is or becomes know or practicable. The memory device 140 may comprise, for example, one or more files, data tables, spreadsheets, registers, databases, and/or memory devices. In some embodiments, the memory device 140 may comprise a Random Access Memory (RAM) and/or cache memory device operable and/or configured to store at least one of image data and instructions defining how and/or when the image data should be processed (e.g., in accordance with embodiments described herein).

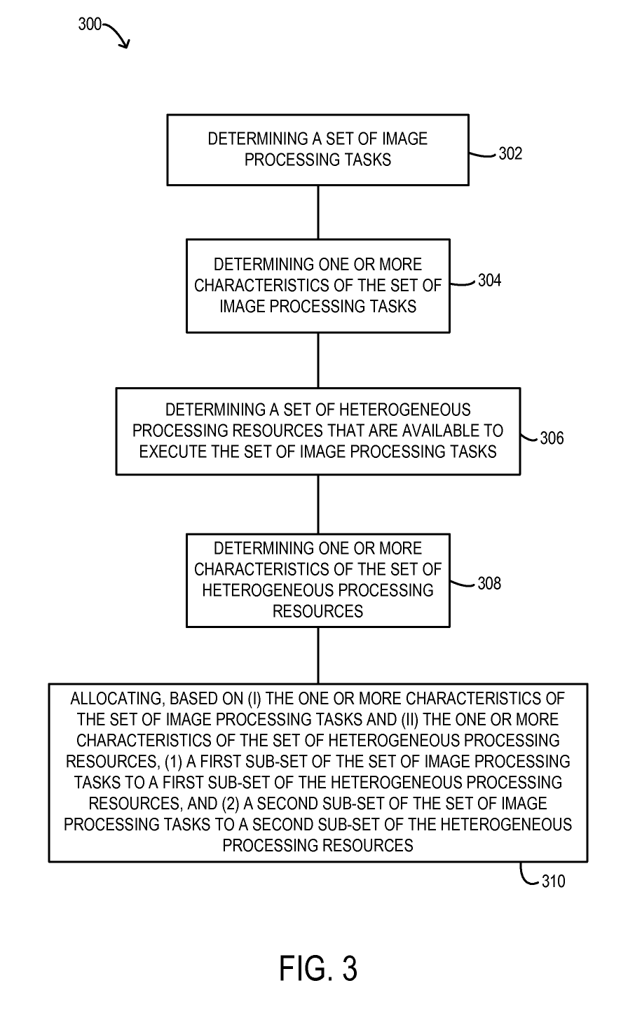

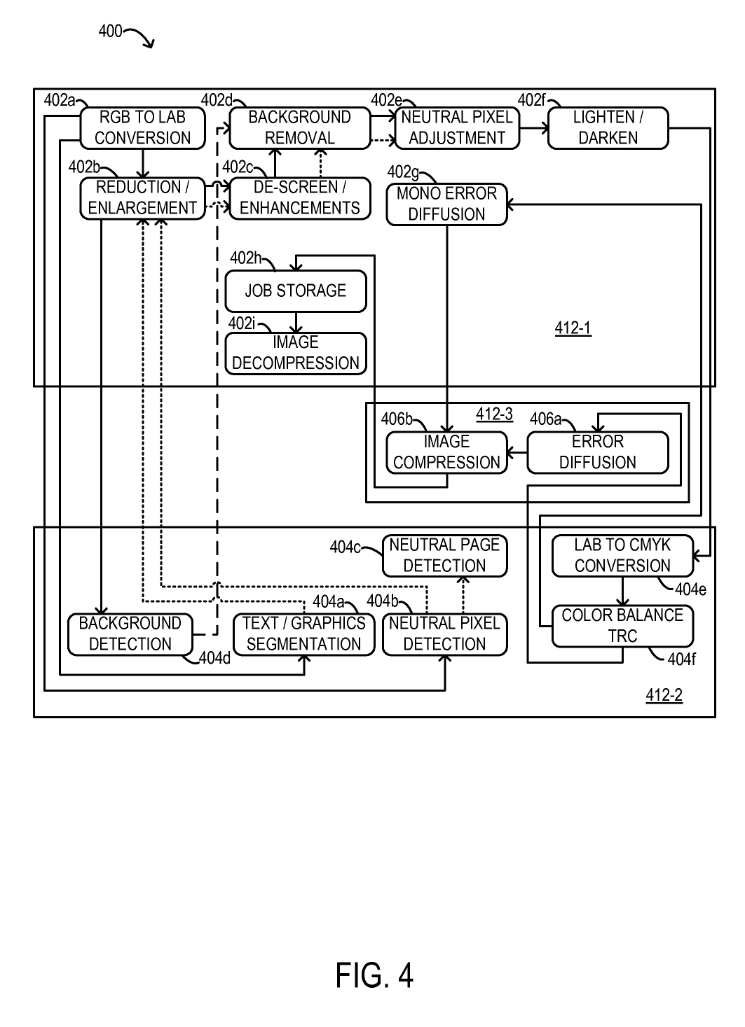

Fewer or more components 112, 114, 116, 120, 122, 130, 140 and/or various configurations of the depicted components 112, 114, 116, 120, 122, 130, 140 may be included in the system 100 without deviating from the scope of embodiments described herein. In some embodiments, the components 112, 114, 116, 120, 122, 130, 140 may be similar in configuration, quantity, and/or functionality to similarly named and/or numbered components as described herein. In some embodiments, the system 100 (and/or portion thereof, such as the processing device 112) may be programmed to and/or may otherwise be configured to execute, conduct, and/or facilitate the methods 300, 400 of FIG. 3 and/or FIG. 4 herein, and/or portions or combinations thereof.

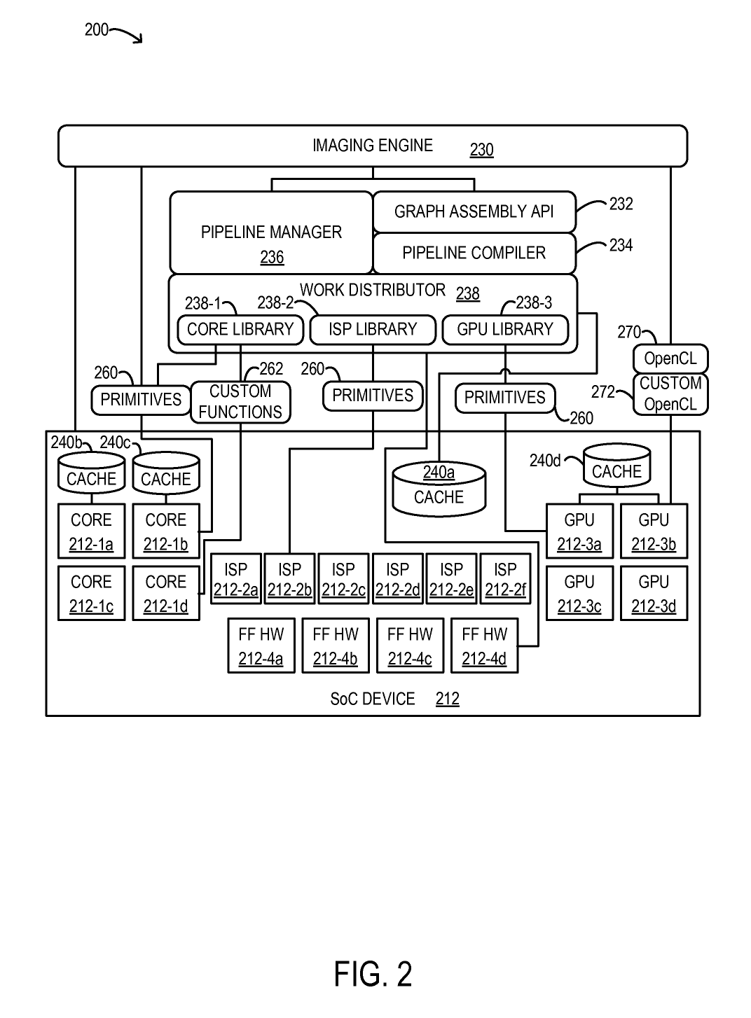

Turning to FIG. 2, a block diagram of a system 200 according to some embodiments is shown. In some embodiments, the system 200 may be utilized to accelerate a set of imaging tasks in a pipeline. The system 200 may, for example, be similar in configuration and/or functionality to the system 100 of FIG. 1 herein. According to some embodiments, the system 200 may comprise a System-on-Chip (SoC) device 212. The SoC device 212 may, in some embodiments, comprise a plurality of heterogeneous processing resources such as a plurality of processing cores 212-1a-d, a plurality of Image Signal Processor (ISP) devices 212-1a-f, a plurality of Graphics Processing Unit (GPU) devices 212-3a-d, and/or a plurality of Fixed-Function Hard-Ware (FFHW) devices 212-4a-d. In some embodiments, the system 200 may comprise code, programs, applications, algorithms, and/or other instructions such as an imaging engine 230. The imaging engine 230 may, for example, comprise a set, module, and/or object or model of instructions and/or rules that are utilized to process image data in accordance with embodiments described herein. According to some embodiments, the imaging engine 230 may comprise (and/or be structurally and/or logically divided or segmented into) various components such as a graph assembly Application Program Interface (API) 232, a pipeline compiler 234, a pipeline manager 236, and/or a work distributor 238. According to some embodiments, the work distributor 238 may comprise (and/or otherwise have access to) one or more libraries such as a core library 238-1, an ISP library 238-2, and/or a GPU library 238-3. In some embodiments, any or all of the imaging engine 230, the graph assembly API 232, the pipeline compiler 234, the pipeline manager 236, the work distributor 238, the core library 238-1, the ISP library 238-2, and/or the GPU library 238-3 (and/or any instructions, classes, attributes, and/or rules thereof) may be stored in one or more various types and/or implementation of recordable media or memory. The system 200 may comprise, for example, various cache devices 240a-d.

In some embodiments, the SoC device 212 may process image data. The imaging engine 230 may, for example, route image data such as function names, arguments, a sequence of operations, and/or base image or video data to various hardware components 212-1a-d, 212-2a-f, 212-3a-d, 212-4a-d, 240a-d of the SoC device 212. According to some embodiments, the routing of the image data may be based on and/or governed by stored rules and/or instructions, such as instructions configured to accelerate the execution of image processing tasks. In some embodiments, the imaging engine 230 may direct and/or send image data and/or tasks directly to one or more hardware components 212-1a-d, 212-2a-f, 212-3a-d, 212-4a-d, 240a-d of the SoC device 212 such as via one or more primitives 260, custom functions 262, and/or utilizing OpenCL 270 and/or customer OpenCL 272 (and/or other programming language that is or becomes known or practicable; e.g., for parallel programming of heterogeneous systems).

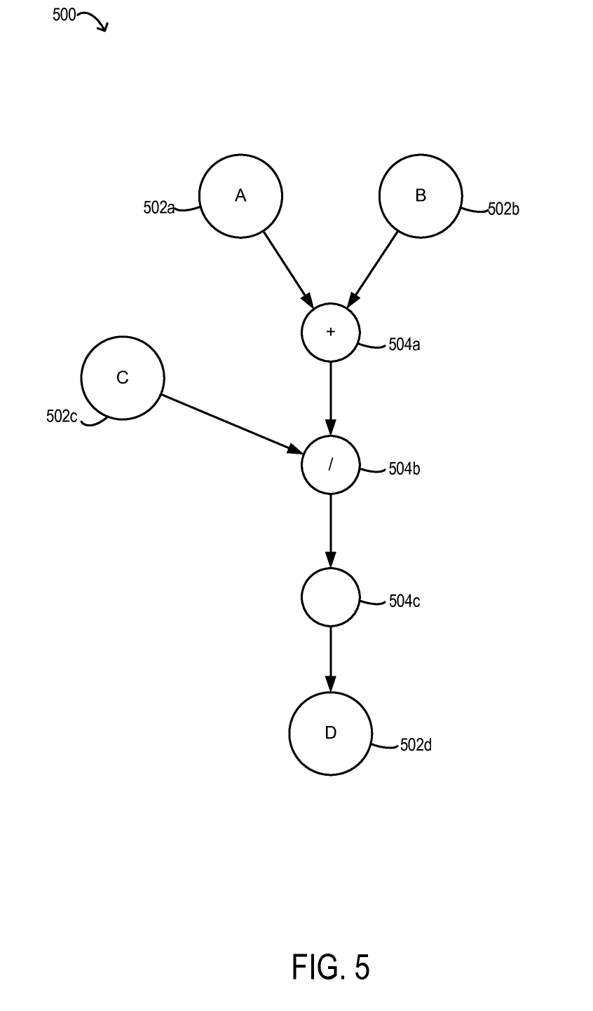

According to some embodiments, the graph assembly API 232 may be utilized to develop, derive, and/or otherwise determine one or more “graphs” (e.g., the example graph 500 of FIG. 5 herein) or other depictions and/or representations of desired image processing tasks (e.g., associated with incoming and/or stored image data). The pipeline compiler 234 may, in some embodiments, compile and or utilize the graph(s) to determine a set of tasks that require execution (e.g., by the SoC device 212). In some embodiments, the pipeline manager 236 may coordinate and/or organize the required tasks such as by sorting the tasks in accordance with various attributes of the tasks (e.g., develop a “pipeline” of required imaging tasks). According to some embodiments, the set of required tasks may be provided (e.g., by the pipeline manager 236) to the work distributor 238.

In some embodiments, the work distributor 238 may implement instructions that are configured to accelerate the set of imaging tasks in the pipeline such as by allocating and/or scheduling the tasks amongst the available hardware processing resource 212-1a-d, 212-2a-f, 212-3a-d, 212-4a-d of the SoC device 212 (e.g., a processing array). The work distributor 238 may, for example, implement, call, activate, and/or execute instructions stored in a first cache 240a of the SoC device 212. In some embodiments, the instructions executed by the work distributor 238 may comprise one or more rules regarding how and/or when imaging tasks should be distributed to the various hardware processing resources 212-1a-d, 212-2a-f, 212-3a-d, 212-4a-d of the SoC device 212. The work distributor 238 may, for example, compare attributes of the required imaging tasks to attributes of the various hardware processing resources 212-1a-d, 212-2a-f, 212-3a-d, 212-4a-d of the SoC device 212. In some embodiments, the work distributor 238 may comprise, store, and/or access one or more libraries of data descriptive of the various hardware processing resources 212-1a-d, 212-2a-f, 212-3a-d, 212-4a-d of the SoC device 212. The work distributor 238 may, for example, access a core library 238-1 (e.g., that may store data identifying and/or describing the processing cores 212-1a-d), an ISP library 238-2 (e.g., that may store data identifying and/or describing the ISP devices 212-2a-f), and/or a GPU library 238-3 (e.g., that may store data identifying and/or describing the GPU devices 212-3a-d).

According to some embodiments, various attributes of the hardware processing resources 212-1a-d, 212-2a-f, 212-3a-d, 212-4a-d of the SoC device 212 (e.g., as determined via the libraries 238-1, 238-2, 238-3) may be utilized to determine how the imaging tasks should be distributed for execution. Whether a particular hardware processing resource 212-1a-d, 212-2a-f, 212-3a-d, 212-4a-d is currently (or expected to be) available, and/or a performance metric, power consumption metric, and/or location (e.g., within the SoC device 212) of a hardware processing resource 212-1a-d, 212-2a-f, 212-3a-d, 212-4a-d may be utilized, for example, to determine which processing tasks should be executed by the various available hardware processing resource 212-1a-d, 212-2a-f, 212-3a-d, 212-4a-d. In some embodiments, attributes of the particular tasks and/or overall pipeline of tasks may also or alternatively be utilized to determine an appropriate and/or desired allocation and/or schedule. Dependencies between tasks, data locality (e.g., location of data required to execute a task), and/or task type or priority may, for example, be determined and utilized to perform the allocation and/or scheduling (e.g., by the work distributor 238).

For example, in the case that a particular type of hardware processing resource 212-1a-d, 212-2a-f, 212-3a-d, 212-4a-d of the SoC device 212 (e.g., a GPU device 212-3a-d) has an affinity for a particular type of task (e.g., as measured by one or more performance metrics), if the particular type of hardware processing resource 212-1a-d, 212-2a-f, 212-3a-d, 212-4a-d (e.g., a GPU device 212-3a-d) is available, and/or is not currently overburdened with other tasks, then the particular type of hardware processing resource 212-1a-d, 212-2a-f, 212-3a-d, 212-4a-d (e.g., a GPU device 212-3a-d) may be the preferred (e.g., highest weighted and/or scored) resource for execution of any tasks of the particular type that require processing by the SoC device 212. In some embodiments, such as in the case that the particular type of task has dependencies to other tasks, those other tasks may also be preferably routed to the particular type of hardware processing resource 212-1a-d, 212-2a-f, 212-3a-d, 212-4a-d (e.g., a GPU device 212-3a-d)—e.g., regardless of the type of the dependent tasks. According to some embodiments, data locality and/or locality of the hardware processing resources 212-1a-d, 212-2a-f, 212-3a-d, 212-4a-d may also or alternatively govern how tasks are allocated and/or scheduled. In the case that a task is typically best performed (e.g., most quickly performed and/or executed) by an ISP device 212-2a-f, that type of task may be scheduled to be performed by an ISP device 212-2a-f (e.g., by the work distributor 238). If, however, arguments and/or data required for performance of the task are already stored in a second memory device 240b in direct communication with and/or locality to a first processing core 212-1a, for example, the task may instead be scheduled and/or allocated to the first processing core 212-1a.

In some embodiments, various costs (e.g., in terms of time, resource tie-up, likely heat generation, and/or required power) may be determined with respect to each required task and any or all of the various (and/or available) hardware processing resources 212-1a-d, 212-2a-f, 212-3a-d, 212-4a-d of the SoC device 212. Heuristics, non-linear optimization, and/or other logical and/or mathematical techniques may be utilized, for example, to determine, set, and/or define rules for how best to allocate and/or schedule image processing tasks. In some embodiments, the optimization technique may be coded into or with the coding of the work distributor 238. In such a manner, for example, the work distributor 238 may be configured to dynamically determine (e.g., “on-the-fly”), based on incoming imaging data, which hardware processing resources 212-1a-d, 212-2a-f, 212-3a-d, 212-4a-d may be best suited for accelerating the imaging tasks in the pipeline. In some embodiments, such as in the case that the work distributor 238 has access to the libraries 238-1, 238-2, 238-3 and the libraries 238-1, 238-2, 238-3 are stored in one or more of the memory devices 240a-d and/or are descriptive of the resources of the SoC device 212, the code defining the work distributor 238 may be fully or partially generic and/or hardware agnostic and may accordingly be easily ported to different SoC devices 212 (and/or other processing systems and/or arrays)—e.g., offering imaging task acceleration capabilities to a variety of hardware setups and/or configurations.

Fewer or more components 212, 212-1a-d, 212-2a-f, 212-3a-d, 212-4a-d, 230, 232, 234, 236, 238, 238-1, 238-2, 238-3, 240a-d and/or various configurations of the depicted components 212, 212-1a-d, 212-2a-f, 212-3a-d, 212-4a-d, 230, 232, 234, 236, 238, 238-1, 238-2, 238-3, 240a-d may be included in the system 200 without deviating from the scope of embodiments described herein. In some embodiments, the components 212, 212-1a-d, 212-2a-f, 212-3a-d, 212-4a-d, 230, 232, 234, 236, 238, 238-1, 238-2, 238-3, 240a-d may be similar in configuration, quantity, and/or functionality to similarly named and/or numbered components as described herein. In some embodiments, the system 200 (and/or a portion thereof, such as the processing device 212) may be programmed to and/or may otherwise be configured to execute, conduct, and/or facilitate the methods 300, 400 of FIG. 3 and/or FIG. 4 herein, and/or portions or combinations thereof.

Turning to FIG. 3, a flow diagram of a method 300 according to some embodiments is shown. In some embodiments, the method 300 may be performed and/or implemented by and/or otherwise associated with one or more specialized and/or computerized processing devices, specialized computers, computer terminals, computer servers, computer systems and/or networks, and/or any combinations thereof (e.g., the processing devices 112, 212 of FIG. 1 and/or FIG. 2 herein, and/or components thereof). The process and/or flow diagrams described herein do not necessarily imply a fixed order to any depicted actions, steps, and/or procedures, and embodiments may generally be performed in any order that is practicable unless otherwise and specifically noted. Any of the processes and/or methods described herein may be performed and/or facilitated by hardware, software (including microcode), firmware, or any combination thereof. For example, a storage medium (e.g., a hard disk, RAM, cache, Universal Serial Bus (USB) mass storage device, and/or Digital Video Disk (DVD)) may store thereon instructions that when executed by a machine (such as a computerized and/or electronic processing device) result in performance according to any one or more of the embodiments described herein.

In some embodiments, the method 300 may be illustrative of a process implemented to accelerate a set of imaging tasks in a pipeline as described herein. According to some embodiments, the method 300 may comprise determining (e.g., by a specially-programmed computer processing device) a set of image processing tasks, at 302. An electronic device may, for example, receive image data and/or may read and/or obtain image data from a stored medium and/or device. For example, a DVD player may read video and/or audio information from a DVD and/or a print device may receive and indication of a print job over a network. In some embodiments, such as in the case that data descriptive of the image processing tasks is read from a memory device that is coupled to and/or comprised within or as part of a device that implements the method 300, the method 300 may comprise transmitting the data descriptive of the image processing tasks (e.g., from one component to another that receives the data).

According to some embodiments, the method 300 may comprise determining (e.g., by the specially-programmed computer processing device) one or more characteristics of the set of image processing tasks, at 304. The data descriptive of the image processing tasks may be analyzed, for example, to infer and/or obtain attribute data regarding the type(s), quantity, priority, and/or interdependencies of the image processing tasks, and/or such attribute data may be looked-up and/or otherwise determined According to some embodiments, the characteristics may include data descriptive of how and/or when such tasks have previously been performed (and/or performance metrics associated therewith—such as a score). In such a manner, for example, the method 300 may take into account previous executions of the method 300 and/or otherwise take into account previous data regarding how similar and/or identical image processing tasks have been routed, allocated, scheduled, and/or otherwise handled.

In some embodiments, the method 300 may comprise determining (e.g., by the specially-programmed computer processing device) a set of heterogeneous processing resources that are available to execute the set of image processing tasks, at 306. Data descriptive of available processing resources such as processing cores, ISP devices, and/or GPU devices may, for example, be stored and accessed, such as with respect to a particular device that executes the method 300. In some embodiments, data descriptive of the resources may be received (e.g., with and/or from the same source as the image processing task data), queried, retrieved (e.g., directly from one or more hardware devices), and/or may be otherwise obtained as is or becomes known or practicable.

According to some embodiments, the method 300 may comprise determining (e.g., by the specially-programmed computer processing device) one or more characteristics of the set of heterogeneous processing resources, at 308. In some embodiments, the characteristic data may be obtained with and/or in the same manner as the data descriptive of the available resources. A database and/or cache data store may, for example, store an indication for each available processing resource, such indication being descriptive of a variety of characteristics of each resource. Such characteristics may include, but are not limited to, (i) an indication of an availability associated with the set of heterogeneous processing resources, (ii) an indication of a performance metric associated with the set of heterogeneous processing resources, (iii) an indication of power consumption associated with the set of heterogeneous processing resources, and/or (iv) an indication of a proximity of stored data in association with the set of heterogeneous processing resources. According to some embodiments, the characteristics may include data descriptive of how and/or when such processing resources have previously been utilized and/or how they performed (and/or performance metrics associated therewith—such as a score, execution time, etc.). In such a manner, for example, the method 300 may take into account previous executions of the method 300 and/or otherwise take into account previous data regarding how well previous imaging tasks were executed by the available resources (e.g., by the processing array).

In some embodiments, the method 300 may comprise allocating (e.g., by the specially-programmed computer processing device), based on (i) the one or more characteristics of the set of image processing tasks and (ii) the one or more characteristics of the set of heterogeneous processing resources, (1) a first sub-set of the set of image processing tasks to a first sub-set of the heterogeneous processing resources, and (2) a second sub-set of the set of image processing tasks to a second sub-set of the heterogeneous processing resources, at 310. The method 300 may be utilized, for example, to allocate and/or schedule the set of processing tasks across available resources in a heterogeneous array in a manner that accelerates the processing of the imaging tasks. In some embodiments, the method 300 may comprise executing, by the first sub-set of the heterogeneous processing resources, the first sub-set of the set of image processing tasks and/or executing, by the second sub-set of the heterogeneous processing resources, the second sub-set of the set of image processing tasks. In the case that a system and/or device that performs and/or facilitates the method 300 comprises and/or controls the processing resources, for example, the system and/or device may cause those resources to process the allocated imaging tasks in accordance with an allocation and/or schedule determined by the system and/or device.

Referring now to FIG. 4, a flow diagram of a method 400 according to some embodiments is shown. In some embodiments, the method 400 may be performed and/or implemented by and/or otherwise associated with one or more specialized and/or computerized processing devices, specialized computers, computer terminals, computer servers, computer systems and/or networks, and/or any combinations thereof (e.g., the processing devices 112, 212 of FIG. 1 and/or FIG. 2 herein, and/or components thereof). In some embodiments, the method 400 may be illustrative of an example print process implemented to accelerate a set of imaging tasks in a pipeline by implementing an allocation across an array of heterogeneous processing resources as described herein.

The method 400 may comprise, for example, execution of a set of first functions 402a-i, execution of a set of second functions 404a-f, and/or execution of a set of third functions 406a-b. In some embodiments, as depicted in FIG. 4, the execution of the functions 402a-i, 404a-f, 406a-b may be allocated and/or schedule to different processing devices 412-1, 412-2, 412-3. The set of first functions 402a-i may be allocated to a first processing device 412-1, for example, the set of second functions 402a-f may be allocated to a second processing device 412-2, and/or set of third functions 402a-b may be allocated to a third processing device 412-3. In some embodiments, the processing devices 412-1, 412-2, 412-3 may be heterogeneous in nature. The first processing device 412-1 may comprise a processing core device (such as one or more of the processing core devices 212-1a-d of FIG. 2), for example, the second processing device 412-2 may comprise an ISP device (such as one or more of the ISP devices 212-2a-f of FIG. 2), and/or the third processing device 412-3 may comprise a GPU device (such as one or more of the GPU devices 212-3a-d of FIG. 2). According to some embodiments, the allocation and/or scheduling of the various functions 402a-i, 404a-f, 406a-b across the heterogeneous processing array 412-1, 412-2, 412-3 may be based on output from an API such as an API and/or compiler utilized to product a graph of a set of desired image processing operations.

Referring to FIG. 5, for example, a diagram of an example graph 500 according to some embodiments is shown. In some embodiments, the graph 500 may be constructed, defined, and/or derived utilizing an API such as the graph assembly API 232 of FIG. 2 herein. The example graph 500 is representative of a simple set of desired mathematical operations defined by the equation:

\sqrt{(a+b)/c}

In some embodiments, the components of the equation may be represented in the graph 500 by a plurality of corresponding arguments 502a-d and functions 504a-c. For example, the arguments “A” 502a, “B” 502b, and “C” 502c may be depicted as being acted upon by an addition function 504a, a division function 504b, and a square root function 504c to produce the argument (and/or result) “D” 502d. The equation illustrated by the graph 500 reveals a simple level of dependencies between the arguments 502a-d and functions 504a-c. For example, the arguments “A” 502a and “B” 502b are required to execute the addition function 504a, which must be executed prior to execution of the division function 504c (which itself requires the argument “C” 502c).

According to some embodiments, these dependencies, the nature of the arguments 502a-d, the nature of the functions 504a-c, and/or data descriptive of data locality, processing affinity, processing availability, power consumption, heat generation, bandwidth, and/or other characteristics, may be utilized to automatically allocate (e.g., in real-time) the execution of the functions 504a-c amongst an array of heterogeneous processing resources. For example, in the case that the arguments “A” 502a and “B” 502b reside external to a processing device, such as in an external and/or off-chip database, RAM, and/or Level 2 (L2) Cache, a processing resource that is capable of performing the addition function 504a the fastest (e.g., it is available, has processing bandwidth that exceeds other resources or is less than capacity, and/or has previously demonstrated a relative strong capability of performing that type of task) may be selected and scheduled to execute the addition function 504a. In the case that either or both of the arguments “A” 502a and “B” 502b already reside in a memory, such as a Level 1 (L1) cache, that is more proximate to a different processing resource, however, the different processing resource may be selected instead. In some embodiments, the expected execution times at each resource may be determined and the resource with the shortest likely execution time may be selected to accelerate the processing of the addition function 504a. According to some embodiments, the entire graph 500 (and/or portions or sections thereof) may be analyzed to proactively plan, schedule, and/or determine how, where, and when the various arguments “A” 502a, “B” 502b, and “C” 502c may be processed and/or the various functions 504a-c may be executed (e.g., in accordance with embodiments described herein).

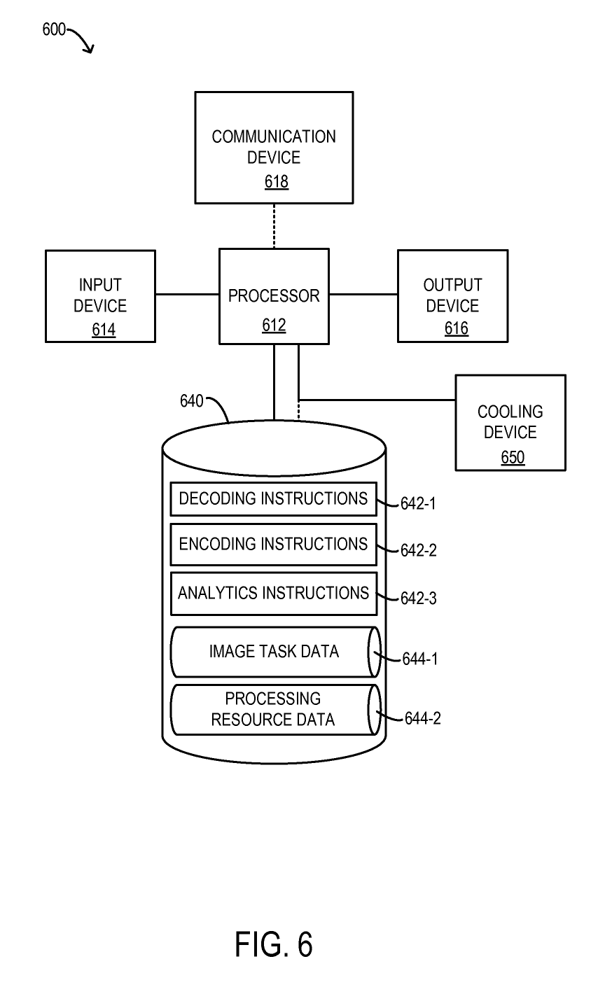

Turning to FIG. 6, a block diagram of an apparatus 600 according to some embodiments is shown. In some embodiments, the apparatus 600 may be similar in configuration and/or functionality to the processing devices 112, 212, 412-1, 412-2, 412-3 of FIG. 1, FIG. 2, and/or FIG. 4 herein. The apparatus 600 may, for example, execute, process, facilitate, and/or otherwise be associated with the methods 300, 400 of FIG. 3 and/or FIG. 4. In some embodiments, the apparatus 600 may comprise an electronic processor 612, an input device 614, an output device 616, a communication device 618, and/or a memory device 640. Fewer or more components 612, 614, 616, 618, 640 and/or various configurations of the components 612, 614, 616, 618, 640 may be included in the apparatus 600 without deviating from the scope of embodiments described herein. In some embodiments, the components 612, 614, 616, 618, 640 of the apparatus 600 may be similar in configuration, quantity, and/or functionality to similarly named and/or numbered components as described herein.

According to some embodiments, the electronic processor 612 may be or include any type, quantity, and/or configuration of electronic and/or computerized processor that is or becomes known. The electronic processor 612 may comprise, for example, an Intel® IXP 2800 network processor or an Intel® XEON™ Processor coupled with an Intel® E7501 chipset. In some embodiments, the electronic processor 612 may comprise multiple inter-connected processors, microprocessors, and/or micro-engines. According to some embodiments, the electronic processor 612 (and/or the apparatus 600 and/or other components thereof) may be supplied power via a power supply (not shown) such as a battery, an Alternating Current (AC) source, a Direct Current (DC) source, an AC/DC adapter, solar cells, and/or an inertial generator. In some embodiments, such as in the case that the apparatus 600 comprises a server such as a blade server, necessary power may be supplied via a standard AC outlet, power strip, surge protector, and/or Uninterruptible Power Supply (UPS) device.

In some embodiments, the input device 614 and/or the output device 616 are communicatively coupled to the electronic processor 612 (e.g., via wired and/or wireless connections, traces, and/or pathways) and they may generally comprise any types or configurations of input and output components and/or devices that are or become known, respectively. The input device 614 may comprise, for example, a keyboard that allows an operator of the apparatus 600 to interface with the apparatus 600 (e.g., a user of an image processing device, such as to set rules and/or preferences regarding image processing in heterogeneous arrays). The output device 616 may, according to some embodiments, comprise a display screen and/or other practicable output component and/or device. The output device 616 may, for example, provide processed image data (e.g., via a website, TV, smart phone, and/or via a computer workstation). According to some embodiments, the input device 614 and/or the output device 616 may comprise and/or be embodied in a single device such as a touch-screen monitor.

In some embodiments, the communication device 618 may comprise any type or configuration of communication device that is or becomes known or practicable. The communication device 618 may, for example, comprise a NIC, a telephonic device, a cellular network device, a router, a hub, a modem, and/or a communications port or cable. In some embodiments, the communication device 618 may be coupled to receive and/or transmit image data in accordance with embodiments described herein. According to some embodiments, the communication device 618 may also or alternatively be coupled to the electronic processor 612. In some embodiments, the communication device 618 may comprise an Infra-red Radiation (IR), Radio Frequency (RF), Bluetooth™, Near-Field Communication (NFC), and/or Wi-Fi® network device coupled to facilitate communications between the electronic processor 612 and one or more other devices (such as a database, DVD-reader or drive, a server, etc.).

The memory device 640 may comprise any appropriate information storage device that is or becomes known or available, including, but not limited to, units and/or combinations of magnetic storage devices (e.g., a hard disk drive), optical storage devices, and/or semiconductor memory devices such as cache memory devices, RAM devices, Read Only Memory (ROM) devices, Single Data Rate Random Access Memory (SDR-RAM), Double Data Rate Random Access Memory (DDR-RAM), and/or Programmable Read Only Memory (PROM). The memory device 640 may, according to some embodiments, store one or more of decoding instructions 642-1, encoding instructions 642-2, and/or analytics instructions 642-3. In some embodiments, the decoding instructions 642-1, encoding instructions 642-2, and/or analytics instructions 642-3 may be utilized by the electronic processor 612 to provide output information via the output device 616 and/or the communication device 618.

According to some embodiments, the decoding instructions 642-1 may be operable to cause the electronic processor 612 to access image task data 644-1 (e.g., in accordance with the methods 300, 400 of FIG. 3 and/or FIG. 4 herein). Image task data 644-1 received via the input device 614 and/or the communication device 618 may, for example, be analyzed, sorted, filtered, decoded, decompressed, ranked, scored, plotted, and/or otherwise processed by the electronic processor 612 in accordance with the decoding instructions 642-1. In some embodiments, image task data 644-1 may be fed by the electronic processor 612 through one or more mathematical and/or statistical formulas, rule sets, policies, and/or models in accordance with the decoding instructions 642-1 to decode incoming image processing data as described herein.

In some embodiments, the encoding instructions 642-2 may be operable to cause the electronic processor 612 to access image task data 644-1 (e.g., in accordance with the methods 300, 400 of FIG. 3 and/or FIG. 4 herein). Image task data 644-1 received via the input device 614 and/or the communication device 618 may, for example, be analyzed, sorted, filtered, decoded, decompressed, ranked, scored, plotted, and/or otherwise processed by the electronic processor 612 in accordance with the encoding instructions 642-2. In some embodiments, image task data 644-1 may be fed by the electronic processor 612 through one or more mathematical and/or statistical formulas, rule sets, policies, and/or models in accordance with the encoding instructions 642-2 to encode processed image data as described herein.

According to some embodiments, the analytics instructions 642-3 may be operable to cause the electronic processor 612 to access image task data 644-1 and/or processing task data 644-2 (e.g., in accordance with the methods 300, 400 of FIG. 3 and/or FIG. 4 herein). Image task data 644-1 and/or processing task data 644-2 received via the input device 614 and/or the communication device 618 may, for example, be analyzed, sorted, filtered, decoded, decompressed, ranked, scored, plotted, and/or otherwise processed by the electronic processor 612 in accordance with the analytics instructions 642-3. In some embodiments, image task data 644-1 and/or processing task data 644-2 may be fed by the electronic processor 612 through one or more mathematical and/or statistical formulas, rule sets, policies, and/or models in accordance with the analytics instructions 642-3 to process imaging tasks in an accelerated manner.

In some embodiments, the apparatus 600 may comprise a cooling device 650. According to some embodiments, the cooling device 650 may be coupled (physically, thermally, and/or electrically) to the electronic processor 612 and/or to the memory device 640. The cooling device 650 may, for example, comprise a fan, heat sink, heat pipe, radiator, cold plate, and/or other cooling component or device or combinations thereof, configured to remove heat from portions or components of the apparatus 600.

According to some embodiments, the apparatus 600 may generally function as a consumer electronics device, for example, which is utilized to process image data utilizing a heterogeneous array of processing resources in an accelerated manner. In some embodiments, the apparatus 600 may comprise a DVD player, a printer, printer server, gaming console, etc. According to some embodiments, the apparatus 600 may comprise and/or provide an interface via which users may visualize, model, and/or otherwise manage image processing tasks (such as an API to create and/or manage function graphs such as the graph 500 of FIG. 5).

Any or all of the exemplary instructions and data types described herein and other practicable types of data may be stored in any number, type, and/or configuration of memory devices that are or become known. The memory device 640 may, for example, comprise one or more data tables or files, databases, table spaces, registers, and/or other storage structures. In some embodiments, multiple databases and/or storage structures (and/or multiple memory devices 640) may be utilized to store information associated with the apparatus 600. According to some embodiments, the memory device 640 may be incorporated into and/or otherwise coupled to the apparatus 600 (e.g., as shown) or may simply be accessible to the apparatus 600 (e.g., externally located and/or situated). In some embodiments, fewer or more data elements 644-1, 644-2 and/or types than those depicted may be necessary and/or desired to implement embodiments described herein.

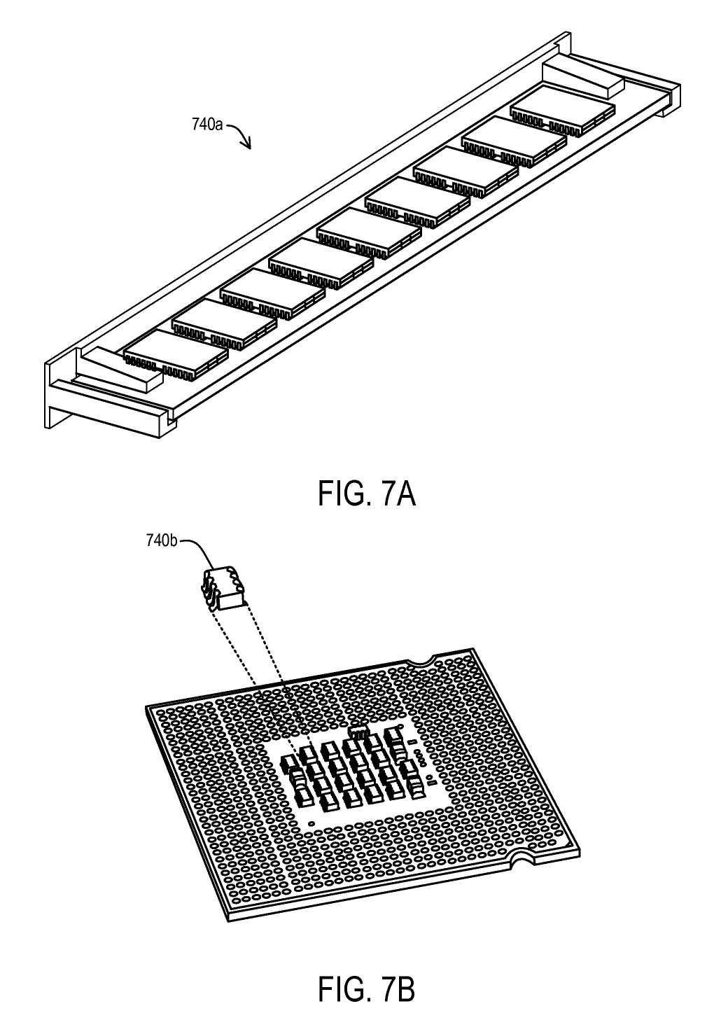

Referring now to FIG. 7A and FIG. 7B, perspective diagrams of exemplary data storage devices 740a-b according to some embodiments are shown. The data storage devices 740a-b may, for example, be utilized to store instructions and/or data such as the analytics instructions 642-3, the image task data 644-1, and/or the processing resource data 644-2, each of which is described in reference to FIG. 6 herein. In some embodiments, instructions stored on the data storage devices 740a-b may, when executed by a processor (such as the processor devices 112, 212, 412-1, 412-2, 412-3 of FIG. 1, FIG. 2, and/or FIG. 4 herein), cause the implementation of and/or facilitate the methods 300, 400 of FIG. 3 and/or FIG. 4 (and/or portions thereof), described herein.

According to some embodiments, the first data storage device 740a may comprise RAM of any type, quantity, and/or configuration that is or becomes practicable and/or desirable. In some embodiments, the first data storage device 740a may comprise an off-chip cache such as an L2 or Level 3 (L3) cache memory device. According to some embodiments, the second data storage device 740b may comprise an on-chip memory device such as a L1 cache memory device.

The data storage devices 740a-b may generally store program instructions, code, and/or modules that, when executed by an electronic and/or computerized processing device cause a particular machine to function in accordance with embodiments described herein. In some embodiments, the data storage devices 740a-b depicted in FIG. 7A and FIG. 7B are representative of a class and/or subset of computer-readable media that are defined herein as “computer-readable memory” (e.g., memory devices as opposed to transmission devices). While computer-readable media may include transitory media types, as utilized herein, the term computer-readable memory is limited to non-transitory computer-readable media.

Some embodiments described herein are associated with a “user device” or a “network device”. As used herein, the terms “user device” and “network device” may be used interchangeably and may generally refer to any device that can communicate via a network. Examples of user or network devices include a PC, a workstation, a server, a printer, a scanner, a facsimile machine, a copier, a Personal Digital Assistant (PDA), a storage device (e.g., a disk drive), a hub, a router, a switch, and a modem, a video game console, or a wireless phone. User and network devices may comprise one or more communication or network components. As used herein, a “user” may generally refer to any individual and/or entity that operates a user device. Users may comprise, for example, customers, consumers, product underwriters, product distributors, customer service representatives, agents, brokers, etc.

As used herein, the term “network component” may refer to a user or network device, or a component, piece, portion, or combination of user or network devices. Examples of network components may include a Static Random Access Memory (SRAM) device or module, a network processor, and a network communication path, connection, port, or cable.

In addition, some embodiments are associated with a “network” or a “communication network”. As used herein, the terms “network” and “communication network” may be used interchangeably and may refer to any object, entity, component, device, and/or any combination thereof that permits, facilitates, and/or otherwise contributes to or is associated with the transmission of messages, packets, signals, and/or other forms of information between and/or within one or more network devices. Networks may be or include a plurality of interconnected network devices. In some embodiments, networks may be hard-wired, wireless, virtual, neural, and/or any other configuration of type that is or becomes known. Communication networks may include, for example, one or more networks configured to operate in accordance with the Fast Ethernet LAN transmission standard 802.3-2002® published by the Institute of Electrical and Electronics Engineers (IEEE). In some embodiments, a network may include one or more wired and/or wireless networks operated in accordance with any communication standard or protocol that is or becomes known or practicable.

As used herein, the terms “information” and “data” may be used interchangeably and may refer to any data, text, voice, video, image, message, bit, packet, pulse, tone, waveform, and/or other type or configuration of signal and/or information. Information may comprise information packets transmitted, for example, in accordance with the Internet Protocol Version 6 (IPv6) standard as defined by “Internet Protocol Version 6 (IPv6) Specification” RFC 1883, published by the Internet Engineering Task Force (IETF), Network Working Group, S. Deering et al. (December 1995). Information may, according to some embodiments, be compressed, encoded, encrypted, and/or otherwise packaged or manipulated in accordance with any method that is or becomes known or practicable.

In addition, some embodiments described herein are associated with an “indication”. As used herein, the term “indication” may be used to refer to any indicia and/or other information indicative of or associated with a subject, item, entity, and/or other object and/or idea. As used herein, the phrases “information indicative of” and “indicia” may be used to refer to any information that represents, describes, and/or is otherwise associated with a related entity, subject, or object. Indicia of information may include, for example, a code, a reference, a link, a signal, an identifier, and/or any combination thereof and/or any other informative representation associated with the information. In some embodiments, indicia of information (or indicative of the information) may be or include the information itself and/or any portion or component of the information. In some embodiments, an indication may include a request, a solicitation, a broadcast, and/or any other form of information gathering and/or dissemination.

Numerous embodiments are described in this patent application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

Devices that are in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for weeks at a time. In addition, devices that are in communication with each other may communicate directly or indirectly through one or more intermediaries.

A description of an embodiment with several components or features does not imply that all or even any of such components and/or features are required. On the contrary, a variety of optional components are described to illustrate the wide variety of possible embodiments of the present invention(s). Unless otherwise specified explicitly, no component and/or feature is essential or required.

Further, although process steps, algorithms or the like may be described in a sequential order, such processes may be configured to work in different orders. In other words, any sequence or order of steps that may be explicitly described does not necessarily indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

The present disclosure provides, to one of ordinary skill in the art, an enabling description of several embodiments and/or inventions. Some of these embodiments and/or inventions may not be claimed in the present application, but may nevertheless be claimed in one or more continuing applications that claim the benefit of priority of the present application. The right is hereby expressly reserved to file additional applications to pursue patents for subject matter that has been disclosed and enabled but not claimed in the present application.

What is claimed is:

1. A method, comprising:
determining, by a specially-programmed computer processing device, a set of image processing tasks;
determining, by the specially-programmed computer processing device, one or more characteristics of the set of image processing tasks;
determining, by the specially-programmed computer processing device, a set of heterogeneous processing resources that are available to execute the set of image processing tasks;
determining, by the specially-programmed computer processing device, one or more characteristics of the set of heterogeneous processing resources; and
allocating, by the specially-programmed computer processing device and based on (i) the one or more characteristics of the set of image processing tasks and (ii) the one or more characteristics of the set of heterogeneous processing resources, (1) a first sub-set of the set of image processing tasks to a first sub-set of the heterogeneous processing resources, and (2) a second sub-set of the set of image processing tasks to a second sub-set of the heterogeneous processing resources.

2. The method of claim 1, further comprising:
executing, by the first sub-set of the heterogeneous processing resources, the first sub-set of the set of image processing tasks.

3. The method of claim 2, wherein the first sub-set of the heterogeneous processing resources comprise at least one of (i) one or more processing cores, (ii) one or more signal processors, (iii) one or more graphics processing units, and (iv) one or more fixed-function hardware units.

4. The method of claim 1, further comprising:
executing, by the second sub-set of the heterogeneous processing resources, the second sub-set of the set of image processing tasks.

5. The method of claim 4, wherein the second sub-set of the heterogeneous processing resources comprise at least one of (i) one or more processing cores, (ii) one or more signal processors, (iii) one or more graphics processing units, and (iv) one or more fixed-function hardware units.

6. The method of claim 1, wherein the specially-programmed computer processing device comprises a System-on-Chip (SoC) device and wherein the set of heterogeneous processing resources comprise at least two of: (i) one or more processing cores, (ii) one or more signal processors, and (iii) one or more graphics processing units.

7. The method of claim 1, wherein the one or more characteristics of the set of image processing tasks comprise at least one of an indication of a dependency associated with the set of image processing tasks and an indication of a type of task associated with the set of image processing tasks.

8. The method of claim 1, wherein the one or more characteristics of the set of heterogeneous processing resources comprise at least one of: (i) an indication of availability associated with the set of heterogeneous processing resources; (ii) an indication of a performance metric associated with the set of heterogeneous processing resources; (iii) an indication of power consumption associated with the set of heterogeneous processing resources; and (iv) an indication of a proximity of stored data in association with the set of heterogeneous processing resources.

9. The method of claim 1, wherein the allocating based on (i) the one or more characteristics of the set of image processing tasks and (ii) the one or more characteristics of the set of heterogeneous processing resources comprises:
determining a stored rule governing the allocation of image processing tasks amongst the set of heterogeneous processing resources; and
determining how to perform the allocating by applying the stored rule to (i) the one or more characteristics of the set of image processing tasks and (ii) the one or more characteristics of the set of heterogeneous processing resources.

10. The method of claim 9, wherein the stored rule is defined by at least one of a user preference and data descriptive of parameter values from previous executions of processing tasks similar to the set of image processing tasks.

11. The method of claim 1, wherein the determining of the set of image processing tasks, comprises:
receiving an indication of at least one of (i) a function name, (ii) an argument, and (iii) a functional dependency that define at least a portion of the set of image processing tasks.

12. The method of claim 11, wherein the indication of the at least one of (i) the function name, (ii) the argument, and (iii) the functional dependency is received via an image processing task graphical API.

13. The method of claim 1, further comprising:
receiving image data upon which the set of image processing tasks are to be performed.

14. The method of claim 1, further comprising:
providing an output comprising image data upon which the set of image processing tasks have been performed.

15. A non-transitory computer-readable medium storing specially-programmed instructions that when executed by an electric processing device, result in:
determining a set of image processing tasks;
determining one or more characteristics of the set of image processing tasks;
determining a set of heterogeneous processing resources that are available to execute the set of image processing tasks;
determining one or more characteristics of the set of heterogeneous processing resources; and
allocating, based on (i) the one or more characteristics of the set of image processing tasks and (ii) the one or more characteristics of the set of heterogeneous processing resources, (1) a first sub-set of the set of image processing tasks to a first sub-set of the heterogeneous processing resources, and (2) a second sub-set of the set of image processing tasks to a second sub-set of the heterogeneous processing resources.

16. The non-transitory computer-readable medium of claim 15, wherein the specially-programmed instructions, when executed by the electric processing device, further result in:
executing, by the first sub-set of the heterogeneous processing resources, the first sub-set of the set of image processing task; and
executing, by the second sub-set of the heterogeneous processing resources, the second sub-set of the set of image processing tasks.

17. The method of claim 16, wherein the non-transitory computer-readable medium comprises a component of a System-on-Chip (SoC) device.

18. A system, comprising:
an input device;
a processing core in communication with the input device;
a signal processor in communication with the input device;
a graphics processing unit in communication with the input device; and
a memory device in communication with the processing core, the signal processor, and the graphics processing unit, the memory device storing specially-programmed instructions that when executed by the system result in:
receiving, via the input device, (i) image data, (ii) an indication of a plurality of functions, (iii) an indication of an argument, and (iii) an indication of a functional dependency between the plurality of functions;
determining, based on at least one of (i) the image data, (ii) characteristics of the plurality of functions, (iii) characteristics of the argument, (iv) the functional dependency between the plurality of functions, (v) characteristics of the processing core, (vi) characteristics of the signal processor, and (vii) characteristics of the graphics processing unit, an allocation of (1) a first portion of the plurality of functions to be executed by the processing core, (2) a second portion of the plurality of functions to be executed by the signal processor, and (3) a third portion of the plurality of functions to be executed by the graphics processing unit;
routing, based on the determining, appropriate portions of the image data to the processing core, the signal processor, and the graphics processing unit; and
transforming the image data by executing the plurality of functions in accordance with the determined allocation.

19. The system of claim 18, further comprising:
an output device in communication with the processing core, the signal processor, and the graphics processing unit, the output device being configured to display the transformed image data to an end-user.

20. The system of claim 18, further comprising:
a cooling device coupled to cool at least one of the processing core, the signal processor, the graphics processing unit, and the memory device.
